(19) United States
(12) Patent Application Publication
(10) Pub. No.: US 2020/0273200 A1
(43) Pub. Date: Aug. 27, 2020

(54) CAMERA LOCALIZATION BASED ON SKELETAL TRACKING

(71) Applicant: Microsoft Technology Licensing, LLC, Redmond, WA (US)

(72) Inventors: Brent Ellwein, Redmond, WA (US); Justin S. Murray, Redmond, WA (US); Julien Monat Rodier, Redmond, WA (US); Timothy M. Clifford, Redmond, WA (US); Payal Jotwani, Redmond, WA (US); Timothy C. Franklin, Redmond, WA (US); Temoojin Chalasani, Redmond, WA (US)

(21) Appl. No.: 16/284,817

(22) Filed: Feb. 25, 2019

(51) Int. Cl. G06T 7/73; G06T 7/80; G06T 7/292; H04N 5/247

(52) U.S. Cl. CPC G06T 7/73; G06T 7/80; G06T 2207/30196; H04N 5/247; G06T 2207/30244; G06T 7/292

(57) ABSTRACT

A system determines relative camera locations based on one or more persons appearing in one or more acquired images. In some instances, the system receives a plurality of images from a plurality of cameras, and identifies a skeletal structure of a person in each of the plurality of images. The system then determines localization parameters for the plurality of cameras based on intrinsic physical characteristics of the plurality of cameras and the identified skeletal structure. The localization parameters may include the positional and/or orientation parameter values for one or more of the cameras. The system then triangulates positions of the identified skeletal structure represented by the plurality of pixels. The system then outputs relative location information of the plurality of cameras based on the localization parameters.

### TECHNICAL FIELD

The subject matter disclosed herein generally relates to camera localization and, in particular, to determining spatial relationships of cameras relative to each other and relative to a space being observed by the cameras.

### BACKGROUND

Cameras are becoming ubiquitous in modem society. Whether used for security, inventory tracking, traffic monitoring, or otherwise, cameras are used by businesses of all sizes. However, these cameras are limited to image collection without generating any additional spatial data unless they are preprogrammed. Current techniques rely on specific hardware sensors, such as depth sensor or a specific arrangement or knowledge of camera location or positioning in order to map a field of view.

When setting up one or more cameras to monitor a particular space without performing a calibration, it is often time consuming to properly configure the cameras. Configuring a camera often includes specifying one or more orientation and/or directional parameters that define the space in which the camera resides, such as horizontal placement, vertical placement, height, pitch, yaw, and roll. When improperly configured, the camera returns incorrect telemetry data and can have difficulties acquiring and/or identifying subjects within an environment visible to the camera. Furthermore, where the camera is part of a network of cameras, an improperly configured camera can result in the loss of data from the improperly configured camera and/or challenges with interpreting data obtained by the cameras communicatively connected to the improperly configured camera.

Furthermore, a conventional implementation often requires that a person place markers or other identifiers in an environment where a camera will be used. The person then uses a calibration wand or other tool to calibrate one or more infrared cameras. This is a time consuming process and uses resources that could be spent elsewhere.

These are just some of the technical problems that arise within the field of image recognition and camera localization.

### SUMMARY

To address these and other problems that arise within the field of camera scene analytics, this disclosure provides for a system for determining relative camera locations, where the system includes one or more hardware processors and a computer-readable storage device that stores computer-executable instructions, which when executed by the one or more hardware processors, configure the system to perform a plurality of operations including receiving a plurality of images generated by a plurality of passive cameras, identifying a skeletal structure of a person in each of the plurality of images, and accumulating feature points of the identified skeletal structure, wherein at least two feature points are acquired from different planes within the identified skeletal structure. The operations further include determining localization parameters values for the plurality of cameras based on the accumulated feature points of identified skeletal structure, wherein the localization parameter values include an extrinsic parameter value, triangulating positions of a plurality of pixels among each of the plurality of images based on the identified skeletal structure for each image, and outputting location information of the plurality of passive cameras based on the localization parameters, wherein the location information indicates a position of each of the passive cameras relative to a determined origin point.

In another embodiment of the system, the plurality of operations further include determining intrinsic physical characteristics of the plurality of passive cameras based on the received plurality of images, wherein the intrinsic physical characteristics include a center position of a lens, a focal length, and field of view information for each of the plurality of cameras.

In a further embodiment of the system, each of the plurality of passive cameras are fixed in location.

In yet another embodiment of the system, the positions of the plurality of pixels include two-dimensional positions.

in yet a further embodiment of the system, the location information identifies a location of each camera of the plurality of passive cameras relative to a universal reference point in a consistent space.

In another embodiment of the system, the plurality of operations further includes receiving additional images from the plurality of passive cameras, tracking an object as it moves through the additional images, and generating an output corresponding to the object based on the tracking.

In a further embodiment of the system, the output corresponding to the object comprises generating positional data of the object as the object moves through an environment visible by the plurality of passive cameras.

In yet another embodiment of the system, the object is visible in a first image from a first camera of the plurality of passive cameras and not visible in a second image from a second camera of the plurality of passive cameras, the first and second images occurring at a first time, and wherein the object is visible in a third image from the second camera and not visible in a fourth image from the first camera, the third and fourth images occurring at a second time.

In yet a further embodiment of the system, outputting location information of the plurality of passive cameras based on the localization parameters comprises outputting a three-dimensional map of the plurality of passive cameras.

This disclosure also describes a method for determining relative camera locations, where the method includes receiving a plurality of images generated by a plurality of passive cameras, identifying a skeletal structure of a person in each of the plurality of images, and accumulating feature points of the identified skeletal structure, wherein at least two feature points are acquired from different planes within the identified skeletal structure. The method also includes determining localization parameters values for the plurality of cameras based on the accumulated feature points of identified skeletal structure, wherein the localization parameter values include an extrinsic parameter value, triangulating positions of a plurality of pixels among each of the plurality of images based on the identified skeletal structure for each image, and outputting location information of the plurality of passive cameras based on the localization parameters, wherein the location information indicates a position of each of the passive cameras relative to a determined origin point,

In another embodiment of the method, the method includes determining intrinsic physical characteristics of the plurality of passive cameras based on the received plurality of images, wherein the intrinsic physical characteristics include a center position of a lens, a focal length, and field of view information for each of the plurality of cameras.

In a further embodiment of the method, each of the plurality of passive cameras are fixed in location.

In yet another embodiment of the method, the positions of the plurality of pixels include two-dimensional positions.

In yet a further embodiment of the method, the location information identifies a location of each camera of the plurality of passive cameras relative to a universal reference point in a consistent space.

In another embodiment of the method, the method includes receiving additional images from the plurality of passive cameras, tracking an object as it moves through the additional images, and generating an output corresponding to the object based on the tracking.

In a further embodiment of the method, generating the output corresponding to the object comprises generating positional data of the object as the object moves through an environment visible by the plurality of cameras.

In yet another embodiment of the method, the object is visible in a first image from a first camera of the plurality of passive cameras and not visible in a second image from a second camera of the plurality of passive cameras, the first and second images occurring at a first time, and wherein the object is visible in a third image from the second camera and not visible in a fourth image from the first camera, the third and fourth images occurring at a second time.

In yet a further embodiment of the method, outputting location information of the plurality of passive cameras based on the localization parameters comprises outputting a three-dimensional map of the plurality of passive cameras.

This disclosure further describes a system for determining relative camera locations, where the system includes means for receiving a plurality of images generated by a plurality of passive cameras, means for identifying a skeletal structure of a person in each of the plurality of images, and means for accumulating feature points of the identified skeletal structure, wherein at least two feature points are acquired from different planes within the identified skeletal structure. The system also includes means for determining localization parameters values for the plurality of cameras based on the accumulated feature points of identified skeletal structure, wherein the localization parameter values include an extrinsic parameter value, means for triangulating positions of a plurality of pixels among each of the plurality of images based on the identified skeletal structure for each image, and means for outputting location information of the plurality of passive cameras based on the localization parameters, wherein the location information indicates a position of each of the passive cameras relative to a determined origin point.

In another embodiment of the system, the system includes means for receiving additional images from the plurality of passive cameras, means for tracking an object as it moves through the additional images, and means for generating an output corresponding to the object based on the tracking.

### BRIEF DESCRIPTION OF THE DRAWINGS

Some embodiments are illustrated by way of example and not limitation in the figures of the accompanying drawings.

FIG. 1 is a diagram illustrating various cameras in a networked environment acquiring an image of a person, according to an example embodiment.

FIG. 2 illustrates skeletal tracking images obtained from the cameras of FIG. 1, according to an example embodiment.

FIG. 3 illustrates a three-dimensional diagram showing the orientation and position of the cameras of FIG. 1, according to an example embodiment.

FIG. 4 illustrates a method, in accordance with an example embodiment, for determining localization parameters based on a skeletal structure identified in one or more acquired images.

FIG. 5 illustrates a method, in accordance with an example embodiment, for using camera localization to track one or more persons over a period of time.

FIG. 6 is a block diagram illustrating components of a machine, according to some example embodiments, able to read instructions from a machine-readable medium (e.g., a machine-readable storage medium or machine-readable storage device) and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without sonic or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The three-dimensional location parameters and/or one or more orientation parameters (e.g., the camera localization parameters) for one or more cameras may be determined through skeletal tracking of a human or one or more moving objects within a field of view of the one or more ca.meras. The determination of the three-dimensional location parameters and/or orientation parameters of the one or more cameras may be determined without information about the current location and/or orientation of the one or more cameras. Previous techniques for determining various localization parameters of a camera are based on predetermined knowledge of some aspect of the camera location, position, or angle. The present systems and methods improve camera effectiveness for security, tracking, inventory, or the like, by generating information (e.g., the values for the one or more localization parameters) otherwise not determinable. The present systems and methods also improve camera effectiveness by not requiring any predetermined knowledge or setup, allowing for a Red-Green-Blue (RGB) or other color-based camera to be used, an after-market solution to be implemented, or localization parameter determination without technical expertise required at the time of that the one or more cameras are initialized or installed.

The following sections describe in detail the systems and methods that may be used to determine localization parameters for one or more cameras having a view of a particular area or environment. As described below, the localization parameters may be determined using one or more acquired images of a particular object, such as a human skeleton, and using skeletal tracking techniques to infer localization parameter values for localization parameters of one or more cameras that have acquired images of the particular object. Examples of skeletal tracking techniques are discussed in U.S. App. Pub. No. 2012/0056800A1, which is incorporated by reference in its entirety.

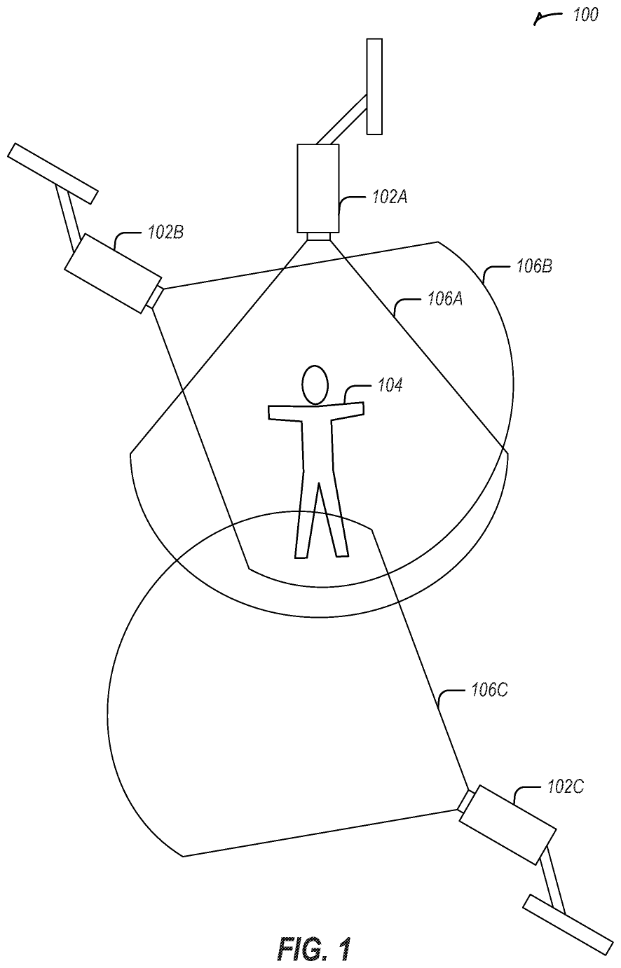

FIG. 1 is a diagram illustrating various cameras 102A-C in a networked environment 100 acquiring an image of a person 104, according to an example embodiment. Each of the cameras 102A-C are associated with a particular field of view 106A-C of the person 104. In this regard, a first camera 102A has a first field of view 106A, a second camera 102B has a second field of view 106B, and a third camera 102C has a third field of view 106C. Each of the fields of view 106A-C may be a different field of view in which the person 104 is located.

In one embodiment, one or more of the cameras 102A-C are configured without a hardware-based depth sensor. For example, one or more of the cameras 102A-C may be implemented as camera having a monochrome and/or complementary metal-oxide-semiconductor (CMOS) sensor. Additionally, and/or alternative, the one or more cameras 102A-C may be implemented as multiple cameras and/or sensors. In yet a further embodiment, one or more of the cameras 102A-C may be implemented to detect light in the infrared spectrum an infrared camera). The cameras 102A-C may be implemented as passive infrared cameras, which one of ordinary skill in the art will understand is a camera that detects infrared light emitting from a source within a field of view of the camera. Different combinations of the foregoing types of cameras are also possible.

One or more of the cameras 102A-C may be configured to detect an object within a corresponding field of view (e.g., in one or more of the field of views 106A-C). In one embodiment, the one or more cameras 102A-C are configured to detect a person 104 within their respective fields of view 106A-C. For example, one or more of the cameras 102A-C may be programmed and/or configured with the parameters that define the object as the person 104. Additionally and/or alternatively, the cameras 102A-C may be communicatively coupled to one or more computers (not shown) that are programmed and/or configured with parameters that define a person, and the one or more computers are programmed and/or configured to identify the person in the images captured by the one or more cameras 102A-C.

The one or more cameras 102A-C (or the computer communicatively coupled thereto) may be configured to track the person 104 as he or she navigates (e.g., walks) through one or more of the fields of view 106A-C. In one embodiment, one or more of the cameras 102A-102C employs one or more skeletal tracking techniques to track the motion of the person 104 through the fields of view 106A-C. The person 104 may be independently tracked in each field of view 106A-C; in other words, the camera 102C may not rely on images acquired by the camera 102A or the camera 102B for tracking the person 104.

In one embodiment, one or more of the pixels within an image acquired by one or more of the cameras 102A-C are assigned a classification to facilitate the tracking of the person 104. For example, one or more pixels may be identified as part of the object (e.g., person 104) or as a non-object (e.g., a background). Through identifying one or more group of pixels classified as belonging to the person 104, the one or more cameras 102A-C identify the person 104 and a skeleton for the person 104. In general, the skeleton for the person 104 may be defined as a group of edges line segments) joined by vertices (e.g., joints).

Each camera 102A-C may independently build and track a skeleton of the person 104. Thus, camera 102A may track a first skeleton, camera 102B may track a second skeleton, and camera 102C may track a third skeleton, In one embodiment, one or more of the cameras 102A-C employ a pose estimation technique to identify a skeleton and its corresponding pose. For example, one or more of the cameras 102A-C may employ the pose estimation technique disclosed in Cao et al., “Realtime Multi-Person 2D Pose Estimation using Part Affinity Fields,” 2017 IEEE Conference on Computer Vision and Pattern Recognition (2017): 1302-1310, the disclose of which is incorporated by reference herein in its entirety. In this manner, each camera 102A-C may determine a pose for the skeleton of the person 104 and track it accordingly.

To build and/or track the skeleton of the person 104, one or more of the cameras 102A-C may be in communication with a computing device and/or computing architecture (not shown). In this regard, the computing device and/or computing architecture may have access to one or more image(s) captured by the cameras 102A-C. The computing device and/or computing architecture may then use a skeleton identification and/or tracking technique to identify and/or track a skeleton as it appears in one or more images acquired by the cameras 102A-C. In one embodiment, the computing device and/or computing architecture leverages a machine-learning algorithm and/or a deep learning algorithm having been trained using one or more images of a person or skeleton. Examples of machine-learning algorithms or deep learning algorithms that may be employed to build and/or track the skeleton of the person 104 include, but are not limited to, a general neural network, a convolutional neural network (CNN), a deep neural network, a recurrent neural network, and other such algorithms or combinations thereof. Thus, the cameras 102A-C may share the images with, or communicate the images to, the computing device and/or computing architecture in order for the computing device and/or computing architecture to construct and/or track the skeleton of the person 104 using one or more machine-learning models and/or deep learning models.

In one embodiment, the computing device and/or computing architecture stores one or more representative data models corresponding to human skeletons. The skeleton data models include one or more model parameters that define a corresponding skeleton. Examples of model parameters include, but are not limited to, skeleton height, skeleton width, the number of vertices in the skeleton, the size of the vertices, the number of limbs (e.g., edges), the length of each edge, and other such model parameters or combinations thereof. In one embodiment, the skeleton data models are used to identify and/or determine which objects appearing in one or more images acquired by the cameras 102A-C correspond to a skeleton. As discussed above, such data models may be used by a deep learning algorithm or machine-learning algorithm

In one embodiment, one or more of the cameras 102A-C accumulate data relating to the motion of the tracked skeleton (e.g., the tracked person 104), as the tracked person 104 moves through the fields of view 106A-C. The data relating to the motion of the tracked skeleton may include, but is not limited to, the position of the tracked skeleton relative to the environment viewable by a particular camera, the orientation of the tracked skeleton relative to the environment viewable by a particular camera, the position of one or more joints and/or limbs of the tracked skeleton, the orientation of one or more joints and/or limbs of the tracked skeleton, the time at which a particular image of the tracked skeleton is captured, and other such parameters and/or attributes or combinations thereof. As discussed below, the position of a tracked object may be triangulated using positional and/or orientation information for two or more of the cameras 102A-C.

In one embodiment, the position of the tracked skeleton, limbs, and/or joints is recorded using a three-dimensional coordinate system, where each object (e.g., the tracked skeleton, limb, and/or joint) is associated with a corresponding three-dimensional coordinate. Similarly, the orientation of the tracked skeleton, limbs, and/or joints is recorded using a three-dimensional orientation system, where each object is associated with a yaw value, roll value, and/or pitch value. With regard to timing information, each coordinate (e.g., position and/or orientation) may be associated with a time value indicating an object's particular position and/or orientation at a particular point in time. The time value may be recorded using one or more measurements of time such as, seconds, microseconds, milliseconds, minutes, hours, or combinations thereof.

in addition to the motion parameters for the tracked skeleton, each joint, and/or each limb, the computing device and/or computer architecture may also record one or more size parameter values that define the shape of one or more objects tracked by the cameras 106A-C. The size parameters may include length, height, width, or combinations thereof. In one embodiment, the size parameter values are initially recorded in relative values (e.g., the size of the tracked object relative to the environment in which the tracked object was captured). Thus, an initial set of size parameters may define a tracked object according to the number of pixels that the tracked object occupies within a particular image. As discussed below, the relative values of the size parameters may then be replaced with Imperial and/or Metric units that define the size of the tracked object, such as centimeters, inches, feet, meters, yards, or other such units that are used to measure the size of an object.

In acquiring the parameters of the tracked skeleton, the computing device and/or computing architecture may leverage one or more semantic relationships that define the structure of a skeleton or of any other object that the cameras 106A-C are configured to track. In this regard, a semantic relationship may define how particular limbs, joints, and other features of a skeleton are related. The semantic relationship may be defined by mathematical formulas that define relationships among the various structures of a skeleton (or any other object). For example, one semantic relationship may define that the pixels representing the left and right shoulders have a distance within a particular range of values. As another example, a second semantic relationship may define that the pixels representing a head are a predetermined distance from the pixels representing the left and/or right shoulders. Yet another semantic relationship may define that the pixels representing the feet are perpendicular to the pixels representing a ground plane. A further semantic relationship may define that the pixels representing the feet are distributed in parallel along the ground plane. In this manner, the semantic relationships define how the pixels of a skeleton are related, which facilitates the determination and tracking of a skeleton by one or more of the machine-learning and/or deep learning algorithms discussed above.

In tracking the skeleton 104, feature points of the acquired images may be used to identify and/or track the skeleton 104. In one embodiment, the feature points that are selected are chosen from different horizontal and/or vertical planes that define the skeleton 104. For example, one or more feature points may be selected from three different horizontal planes that define the skeleton 104, such as one or more feature points from the head of the skeleton (e.g., the first plane), one or more feature points from the shoulders (e.g., the second plane), and one or more feature points from the feet (e.g., the third plane). By selecting the feature points in this manner, the disclosed architecture develops a more accurate representation of the skeleton 104, which translates into a determination of more accurate localization parameters for the cameras 102A-C.

The one or more cameras 102A-C may accumulate the motion data of the tracked skeleton (e.g., the position and/or orientation at particular points in time) over a predetermined period of time. In one embodiment, the predetermined time period is two minutes. However, other predetermined time periods are also possible, such as five minutes, ten minutes, an hour, or other amounts of time. In capturing images of the one or more tracked objects, the one or more cameras 102A-C may capture a set of images based on the framerate recordable by the one or more cameras 102A-C. Thus, where the cameras 102A-C are capable of recording in 30 frames per second (fps), the cameras 102A-C may record 1800 images over a time period of one minute (e.g., 60 seconds). As discussed above, each image captured by the cameras 102A-C may include one or more objects detectable by a computing device and/or computer architecture (e.g., via one or more object recognition techniques), and each detected object may be associated with one or more motion and/or size parameters.

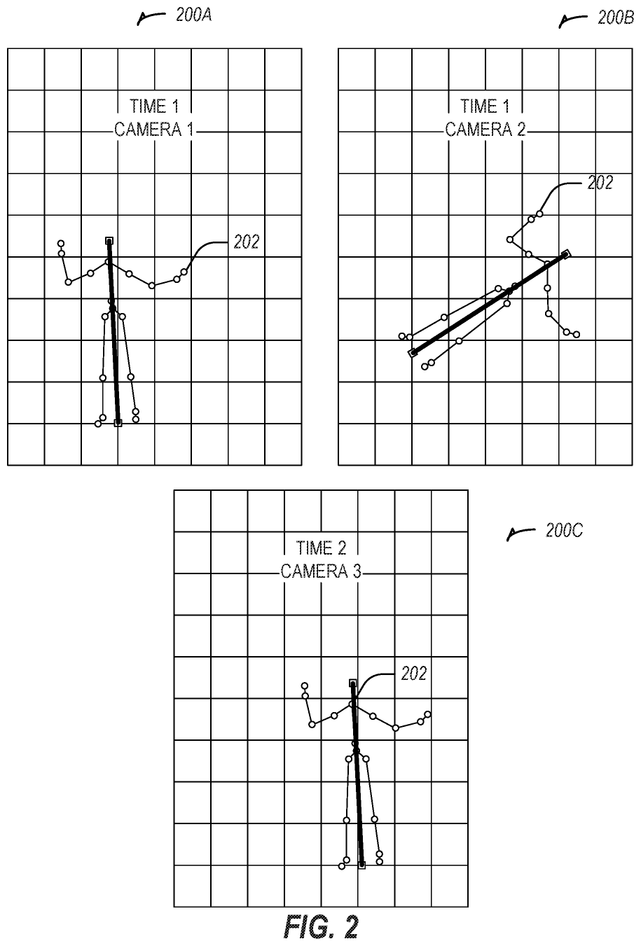

FIG. 2 illustrates skeletal tracking images 200A-C obtained from the cameras 102A-C of FIG. 1, according to an example embodiment. Each image 200A-C includes a skeleton 202 being tracked by the one or more cameras 102A-C. Furthermore, and as shown in images 200A-C, each skeleton 202 comprises one or more joints and/or one or more limbs. As discussed above, each skeleton 202, joint, and/or limb may be associated with multiple parameter values that define the position and/or orientation of the skeleton 202. In addition, each of the images 200A-C may be associated with a corresponding time parameter value that indicates a time at which the particular image occurred or was acquired by a corresponding camera 102A-C. Accordingly, image 200A is one example of an image acquired at time T1 by the camera 102A, image 200B is one example of an image acquired at time T1 by the camera 102B, and image 200C is one example of an image acquired at time T1 by the camera 102C. Although not shown, the camera 102C may also acquire an image at time Ti and the cameras 102A-B may also acquire images at time T1. In some instances, an object visible in a first plurality of images acquired by one or more of the cameras 102A-C may not be visible in a second plurality of images acquired by the one or more cameras 102A-C. Thus, skeleton 202 may appear in some of the images acquired by camera 102A at time T1 but may not appear in some of the images acquired by camera 102C at time T2.

Using the one or more images and/or parameter values for the skeleton 202, the computing device and/or computer architecture may attempt to align and/or match images that occur at, or approximately at, the same, time. In one embodiment, the computing device and/or computer architecture matches pixels from the acquired one or more images to assign, or classify, the pixels as belonging to the same skeleton. One example of a matching technique that may be performed to match one or more of the pixels is disclosed in Zhang, et al., “A robust technique for matching two uncalibrated images through the recovery of the unknown epipolar geometry,” in Artificial intelligence, Vol. 78 (1995), the disclosure of which is hereby incorporated by reference in its entirety.

The computing device and/or computer architecture may determine one or more positional and/or orientation parameter values for the cameras 102A-C based on the one or more images acquired by corresponding cameras 102A-C. In this regard, the computing device and/or computer architecture may determine the positional and/or orientation parameter values for camera 102A based on one or more images that camera 102A acquired, the positional and/or orientation parameter values for camera 102B based on one or more images that camera 102B acquired, and the positional and/or orientation parameter values for camera 102C based on one or more images that camera 102C acquired. In one embodiment, the determination of the positional parameter values and/or orientation parameter values for each of the cameras 102A-C is based on matched images having equal, similar, or substantially similar time parameter values. For example, the positional parameter values and/or the orientation parameter values for camera 102A may be based on a first plurality of images matched at time T₁, on a second plurality of images matched at time T₂, and/or a third plurality of images matched at time T₃.

In addition, the positional parameter values and/or orientation parameter values may be determined based on one or more intrinsic physical characteristics of the cameras 102A-C. Examples of intrinsic physical characteristics include, but are not limited to, a center position of a lens, a focal length, field of view information, any other intrinsic physical characteristic, or combinations thereof. In one embodiment, one or more of the intrinsic physical characteristics are provided to and/or previously provided to the computing device or computer architecture that matches one or more of the acquired images. For example, the computing device and/or computer architecture may be provided with the focal length for one or more of the cameras 102A-C, the angle of the environment viewable by one or more of the cameras 102A-C, and other intrinsic physical characteristics of the one or more cameras 102A-C.

The determination of the positional and/or orientation parameter values may be performed using one or more techniques. For example, one or more of the intrinsic physical characteristics may be determined through bundle adjustment, which one of ordinary skill in the art would understand is a technique of simultaneously refining three-dimensional coordinates describing a scene geometry, parameters of relative motion, and optical characteristics of the cameras 102A-C, according to an optimality criterion involving corresponding image projections of all points. In general, bundle adjustment attempts to minimize a reprojection error between image locations of observed and predicted image points, which may be expressed as a sum of squares of a large number of nonlinear, real-valued functions. In one implementation, minimization may be achieved using a nonlinear least-squares algorithm, such as the Levenberg-Marquardt equation.

In performing bundle adjustment, the algorithm may be provided with an initial estimate or an initial value for one or more of the intrinsic physical characteristic values of one or more of the cameras 102A-C. For example, a two-dimensional table may associate camera manufacturers and/or models with particular, intrinsic physical characteristic values. Thus, where the cameras 102A-C are known to be of a particular make and/or model, initial or default values are selected from the two-dimensional table that correspond with the particular make and/or model. Where the make and/or model of the cameras 102A-C are unknown, global default values may be selected for each of the intrinsic physical characteristics.

Additional and/or alternative algorithms may be employed to determine the intrinsic physical characteristics of the cameras 102A-C. One such algorithm is the eight-point algorithm, which is described in R. I. Hartley, “In defense of the eight-point algorithm,” in IEEE Transactions on Pattern Analysis and Machine Intelligence, vol. 19, no. 6, pp. 580-593, June 1997, the disclosure of which is incorporated by reference in its entirety. Another algorithm that may be used is the five-point algorithm, which is discussed in Nistér, David, “An Efficient Solution to the Five-Point Relative Pose Problem,” IEEE Transactions on Pattern Analysis and Machine Intelligence, Vol. 26 No. 6, June 2004, the disclosure of which is incorporated by reference in its entirety. Where the five-point algorithm is implemented, the algorithm may be provided with initial values for one or more of the intrinsic physical characteristics of the cameras 102A-C. As explained above, the initial values for the five-point algorithm may be provided from the two-dimensional table of camera makes and/or models.

The positional parameter values for each of the cameras 102A-C may include a three-dimensional coordinate value, where the coordinate system is established relative to the cameras 102A-C. Thus, in one embodiment, one camera, such as a camera 102A, may be designated as an origin point having a three-dimensional coordinate value of (0, 0, 0). Additionally, and/or alternatively, the coordinate system may be established relative to a ground plane constructed from the one or more acquired images. In yet another alternative embodiment, the coordinate system is established relative to sea level, and the three-dimensional coordinate values assigned to the cameras 102A-C are measured in a unit corresponding to distance (e.g., feet, meters, yards, etc.).

The orientation parameter values for each of the cameras 102A-C may include a set of three orientation parameters corresponding to pitch, roll, and/or yaw. In one embodiment, one of the cameras 102A is selected as an origin point and the pitch, roll, and/or yaw parameter values are determined relative to the orientation of the camera 102A. In an alternative embodiment, an arbitrary origin point is selected that is proximate to one or more of the cameras 102A-C, and the pitch, roll, and/or yaw parameter values are defined relative to the arbitrary origin point. In a further embodiment, the orientation parameters for one or more of the cameras 102A-C may be defined as a quaternion, which may include a set of four numbers representing a rotation axis (e.g., X-axis. Y-axis, and Z-axis) and a rotation angle (e.g., θ) to rotate around that axis.

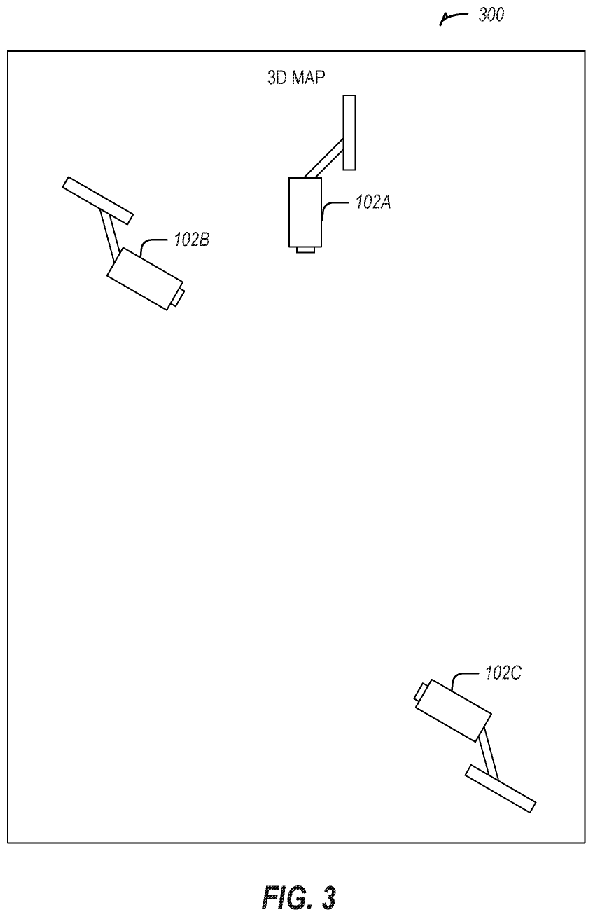

Having determined the positional and/or orientation parameter values for the cameras 102A-C, the computing device and/or computer architecture may then construct a three-dimensional diagram of the environment in which the cameras 102A-C are located. FIG. 3 illustrates a three-dimensional diagram 300 showing the orientation and position of the cameras 102A-C of FIG. 1, according to an example embodiment. In one embodiment, the three-dimensional diagram 300 comprises a ground plane over which the person 104 traverses and one or more boundary walls that define the environment viewable by the cameras 102A-C. The vertices and/or line segments that define the boundary walls may be determined by perform one or more object recognition algorithms on the objects within the field of views 106A-C of the cameras, and selecting those objects that are determined to have the highest depth value (e.g., are furthest away from one or more of the cameras 102A-C). By constructing a three-dimensional diagram 300 of the environment in which the cameras 102A-C are located, the computing device and/or computer architecture can construct an analytical model that represents how various objects traverse and move about the environment viewable by the cameras 102A-C.

In one embodiment, the cameras 102A-C track and/or observe objects as they move through the various fields of view 106A-C. As these objects, such as the person 104, move through the various fields of view 106A-C, the computing device and/or computer architecture maintains positional information for each object (e.g., the two- or three-dimensional coordinates) and associates the positional information with corresponding time information. In one embodiment, the positional information is recorded at predetermined time intervals (e.g., every three seconds). Further still, one or more of the tracked objects may be triangulated using the positional parameter values and/or orientation parameter values for two or more of the cameras 102A-C. The triangulation of the tracked objects yields the position of the tracked objects in three-dimensional space. One methodology for performing the triangulation of the tracked objected is discussed in Hartley, et al., “Triangulation,” in Computer Vision and Image Understanding, Vol. 68 No. 2, November 1997: 146-157, the disclosure of which is hereby incorporated by reference in its entirety.

The recording of the positional information facilitates the construction of a heatmap depicting the location of particular objects given a predetermined time interval. For example, colored pixels, representing the positional information for various objects, may be overlaid the three-dimensional diagram 300. Each set of pixels may be associated with a particular color to represent a corresponding object. Additionally, and/or alternatively, the colors of the pixels may be used to generically identify objects (e.g., white pixels identify men, red pixels identify women, blue pixels identify people below a predetermined age threshold, etc.). In this regard, particular colors of the pixels may be associated with particular demographics. Further still, a particular color may be associated with a particular individual to better identify the individual and have the positional information for that individual be more apparent than other objects.

The positional overlay thus depicts where various objects were located in the environment at particular points in time. This information is useful in predicting where objects are likely to congregate or potential problems in the environment that restrict the flow of motion of the objects. For example, such a heatmap may be useful in identifying where a bottleneck is occurring in a crowded space.

In another implementation, the disclosed systems and methods maintain positional data on one or more objects viewable by the cameras 102A-C. For example, the positional data may include the coordinates of a person as he or she moves through the fields of view of the cameras 102A-C. The positional data associated with the tracked person may facilitate an understanding of how the person moved through scene visible in the cameras 102A-C, and may be used to determine potential objectives that may be accomplished by the tracked person (e.g., a tracked person that purchases a particular product in a store in a first pass of the store with an advertisement, may then be directed to an upsell associated with the particular product). Additionally and/or alternatively, one or more machine-learning algorithms may be employed to train a model associated with one or more demographics of the tracked person (e.g., age, gender, ethnicity, and other such demographics)

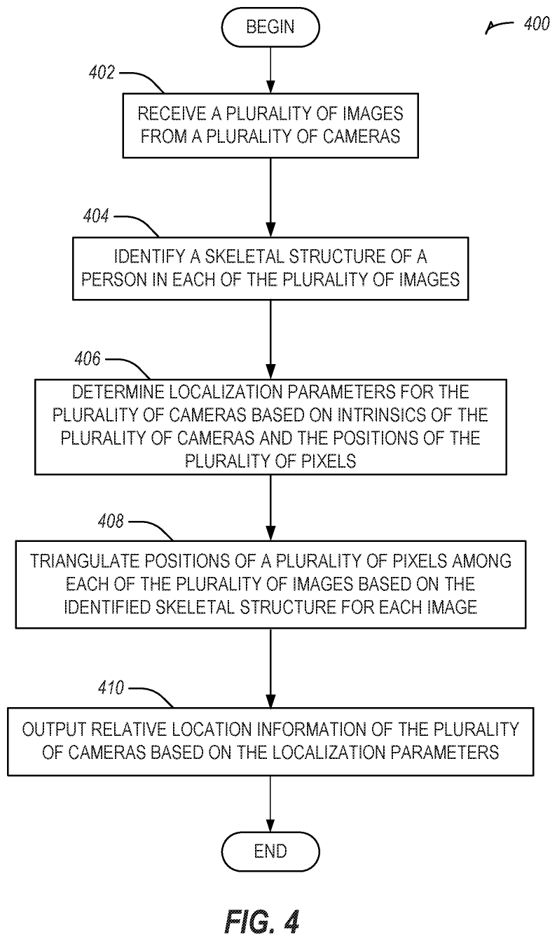

FIG. 4 illustrates a method 400, in accordance with an example embodiment, for determining localization parameters based on a skeletal structure identified in one or more acquired images. The method 400 may be implemented by one or more of the cameras 102A-C illustrated in FIG. 1 and is discussed by way of reference thereto.

Initially a computer device and/or computer architecture receives one or more images from the cameras 102A-C (Operation 402). Thereafter, the computing device and/or computer architecture identifies objects within the plurality of images, such as a person 104. The computing device and/or computer architecture then constructs a skeleton for the person 104 as described above (Operation 404). Using the plurality of images, the computing device and/or computer architecture then matches the objects appearing in the various images. Using the various images, the computing device and/or computer architecture then determines one or more localization parameter values for the cameras 102A-C (Operation 406), which may include the positional and/or orientation parameter values for each of the cameras 102A-C. This information may then be used in triangulating one or more tracked objects and/or within the field of views 106A-C of the various cameras 102A-C (Operation 408). The positional and/or orientation information obtained in this way may then be output to a display or other device for further analysis (Operation 410).

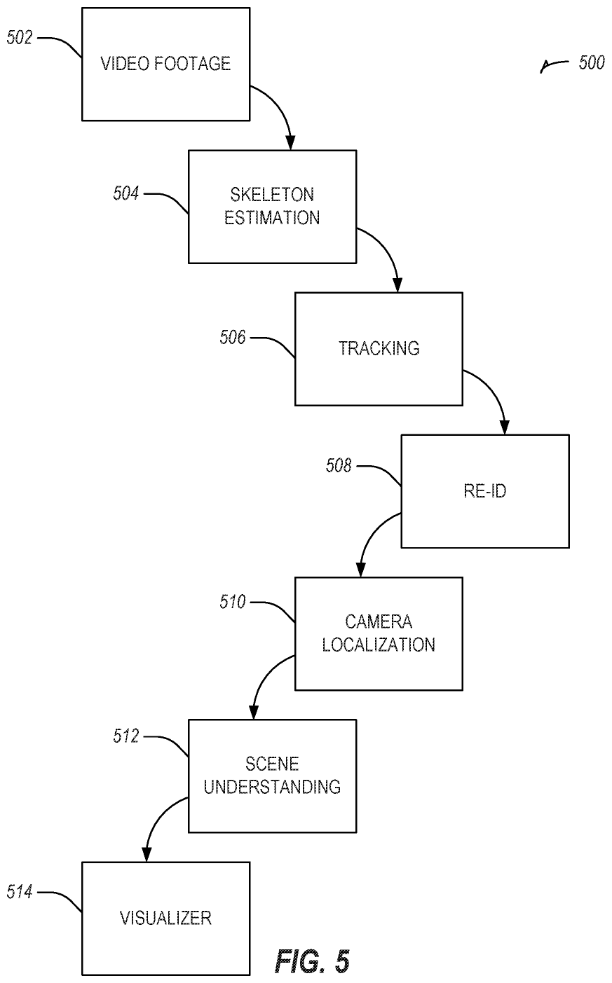

FIG. 5 illustrates a method, in accordance with an example embodiment, for using camera localization to track one or more persons over a period of time. The method 500 may be implemented using one or more of the cameras 102A-C illustrated in FIG. 1 and is discussed by way of reference thereto.

Initially, video footage (e.g., one or more sets of images) are obtained from one or more of the cameras 102A-C (Operation 502). Using the obtained images, one or more skeletons are identified in one or more of the images (Operation 504). The one or more skeletons are then tracked as they move through one or fields of view 106A-C of the cameras 102A-C (Operation 506), A re-identification is then performed for one or more skeletons (Operation 508).

At Operation 508, the re-identification is performed to identify a consistent skeleton across images acquired by the cameras 102A-C. Re-identification is technically beneficial because it ensures that the correct skeletons are being used in the determination of localization parameters for the cameras 102A-C. The re-identification of the tracked skeletons may be performed using one or more of the machine-learning and/or deep learning algorithms discussed above. In one embodiment, where a single skeleton is being used as input to localization, Operation 508 may not be performed.

Thereafter, and as discussed above, camera localization is then performed to determine one or positional and/or orientation parameter values for one or more of the cameras 102A-C (Operation 510). In some embodiments, re-identification may be performed after Operation 510 to improve the reliability of establishing three-dimensional coordinates for the tracked skeletons. For example, re-identification may be used to identify consistent skeletons between images acquired by the cameras 102A-C, and then triangulation may be used to discover the three-dimensional coordinates of the skeleton. In this manner, re-identification and triangulation may be used together to improve confidence of three-dimensional skeleton solutions. In general, re-identification corresponds to analyzing the appearance and temporal similarity of skeletons from different camera images, and determining which skeletons belong to consistent people across the different camera images.

Using the camera localization parameter values, a three-dimensional diagram and/or model is then constructed (Operation 512). As one or more objects move through the fields of view 106A-C of the cameras 102A-C, the objects' positional and/or orientation information may be stored. Using the three-dimensional diagram and/or model, the objects' positional and/or orientation may be visualized (Operation 514). In one embodiment, the visualization is in the form of a heatmap, which illustrates the locations most often traversed by the tracked objects. Additionally and/or alternatively, the heatmap may illustrate the time spent by the tracked objects in a particular location.

in this manner, this disclosure provides for systems and methods that determine one or more camera localization parameters from one or more tracked skeletons. One of the challenges in deploying one or more cameras in an environment is determining the localization parameters for such cameras. For example, in some instances, the cameras may be deployed in areas that are hard to reach or in unfamiliar scenarios. However, the cameras may be in an environment that are populated with people or through which people are known to travel. By tracking the skeletons of the people, the localization parameters for the one or more cameras can be determined. Thus, this disclosure provides a technical solution to a problem arising from the field of computer vision and object recognition.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be perfonned by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5 are implemented in some embodiments in the context of a machine and an associated software architecture. The sections below describe a. representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

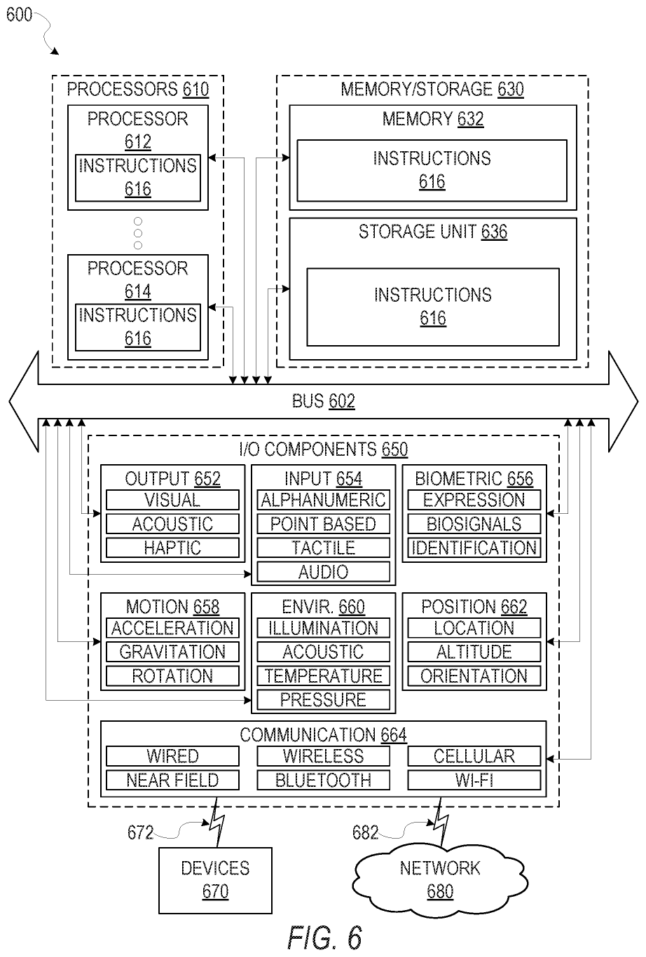

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 5 shows a diagrammatic representation of the machine 600 in the example form of a computer system, within which instructions 616 (e.g., software, a program, an application, an apples, an app, or other executable code) for causing the machine 600 to perform any one or more of the methodologies discussed herein may be executed. For example, the instructions 616 may cause the machine 600 to execute the flow diagrams of FIGS. 4-5. Additionally, or alternatively, the instructions 616 may implement one or more of the components of FIG. 1. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a personal digital assistant (PDA), or any machine capable of executing the instructions 616, sequentially or otherwise, that specify actions to be taken by machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RTIC), another processor, or any suitable combination thereof) may include, for example, processor 612 and processor 614 that may execute the instructions 616. The term “processor” is intended to include multi-core processor that may comprise two or more independent processors (sometimes referred to as “cores”) that may execute instructions 616 contemporaneously. Although FIG. 5 shows multiple processors 610, the machine 600 may include a single processor with a single core, a single processor with multiple cores (e.g., a multi-core process), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a hardware device able to store instructions 616 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single physical medium or multiple physical media (e.g., a centralized or distributed database, or associated caches and servers) able to store instructions 616. The term “machine-readable medium” shall also be taken to include any physical medium, or combination of multiple physical media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via coupling 682 and coupling 672 respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFII)) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geo-location, location via Wi-Fi® signal triangulation, location via detecting a NEC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or other type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to devices 670. The term “transmission medium” shall be taken to include any intangible medium that is capable of storing, encoding, or carrying instructions 616 for execution by the machine 600, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality' presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system for determining relative camera locations, the system comprising:
one or more hardware processors; and
a computer-readable storage device that stores computer-executable instructions, which when executed by the one or more hardware processors, configure the system to perform a plurality of operations comprising:
receiving a plurality of images generated by a plurality of cameras;
identifying a skeletal structure of a person in each of the plurality of images;
accumulating feature points of the identified skeletal structure, wherein at least two feature points are acquired from different planes within the identified skeletal structure;
determining localization parameter values for the plurality of cameras based on the accumulated feature points of the identified skeletal structure, wherein the localization parameter values indicate relative position and orientation of each of the plurality of cameras with respect to one another;
triangulating positions of a plurality of pixels among each of the plurality of images based on the identified skeletal structure for each image; and
outputting location infoiination of the plurality of cameras using the localization parameter values, wherein the location information indicates a position of each of the cameras relative to an identified origin point.

2. The system of claim 1, wherein the plurality of operations further include determining intrinsic physical characteristics of the plurality of cameras based on the received plurality of images, wherein the intrinsic physical characteristics include a center position of a lens, a focal length, and field of view information for each of the plurality of cameras.

3. The system of claim I, wherein the plurality of cameras are passive cameras, and wherein each of the plurality of passive cameras are fixed in location.

4. The system of claim 1, wherein the positions of the plurality of pixels include two-dimensional positions.

5. The system of claim 1, wherein the location information identifies a location of each camera of the plurality of cameras relative to a universal reference point in a consistent space.

6. The system of claim I., wherein the plurality of operations further include receiving additional images from the plurality of cameras;
tracking an object as it moves through the additional images; and
generating an output corresponding to the object based on the tracking.

7. The system of claim 6, wherein the output corresponding to the object comprises generating positional data of the object as the object moves through an environment visible by the plurality of cameras.

8. The system of claim 7, wherein the object is visible in a first image from a first camera of the plurality of cameras and not visible in a second image from a second camera of the plurality of cameras, the first and second images occurring at a first time, and wherein the object is visible in a third image from the second camera and not visible in a fourth image from the first camera, the third and fourth images occurring at a second time.

9. The system of claim 1, wherein outputting location information of the plurality of cameras based on the localization parameters comprises outputting a three-dimensional map of the plurality of cameras.

10. A method for determining relative camera locations, the method comprising:
receiving a plurality of images generated by a plurality of cameras;
identifying a skeletal structure of a person in each of the plurality of images;
accumulating feature points of the identified skeletal structure, wherein at least two feature points are acquired from different planes within the identified skeletal structure;
determining localization parameter values for the plurality of cameras based on the accumulated feature points of the identified skeletal structure, wherein the localization parameter values indicate relative position and orientation of each of the plurality of cameras with respect to one another;
triangulating positions of a plurality of pixels among each of the plurality of images based on the identified skeletal structure for each image; and
outputting location information of the plurality of cameras using the localization parameter values, wherein the location information indicates a position of each of the cameras relative to an identified origin point.

11. The method of claim 10, further comprising determining intrinsic physical characteristics of the plurality of cameras based on the received plurality of images, wherein the intrinsic physical characteristics include a center position of a lens, a focal length, and field of view infoiination for each of the plurality of cameras.

12. The method of claim 10, wherein the plurality of cameras are passive cameras, and wherein each of the plurality of passive cameras are fixed in location.

13. The method of claim 10, wherein the positions of the plurality of pixels include two-dimensional positions.

14. The method of claim 10, wherein the location information identifies a location of each camera of the plurality of cameras relative to a universal reference point in a consistent space.

15. The method of claim 10, further comprising:
receiving additional images from the plurality of cameras;
tracking an object as it moves through the additional images; and
generating an output corresponding to the object based on the tracking.

16. The method of claim 15, wherein generating the output corresponding to the object comprises generating positional data of the object as the object moves through an environment visible by the plurality of cameras.

17. The method of claim 16, wherein the object is visible in a first image from a first camera of the plurality of cameras and not visible in a second image from a second camera of the plurality of cameras, the first and second images occurring at a first time, and wherein the object is visible in a third image from the second camera and not visible in a fourth image from the first camera, the third and fourth images occurring at a second time.

18. The method of claim 10, wherein outputting location information of the plurality of cameras based on the localization parameters comprises outputting a three-dimensional map of the plurality of cameras.

19. A system for determining relative camera locations, the system comprising:
means for receiving a plurality of images generated by a plurality of cameras;
means for identifying a skeletal structure of a person in each of the plurality of images;
means for accumulating feature points of the identified skeletal structure, wherein at least two feature points are acquired from different planes within the identified skeletal structure;
means for determining localization parameter values for the plurality of cameras based. on the accumulated feature points of the identified skeletal structure, wherein the localization parameter values indicate relative position and orientation of each of the plurality of cameras with respect to one another;
means for triangulating positions of a plurality of pixels among each of the plurality of images based on the identified skeletal structure for each image; and
means for outputting location information of the plurality of cameras using the localization parameter values, wherein the location information indicates a position of each of the cameras relative to an identified origin point.

20. The system of claim 19, further comprising:
means for receiving additional images from the plurality of cameras;
means for tracking an object as it moves through the additional images; and
means for generating an output corresponding to the object based on the tracking.
